(19) United States
(12) Patent Application Publication
(10) Pub. No.: US 2013/0105561 A1
(43) Pub. Date: May 2, 2013

(54) DRY ICE CLEANING OF METAL SURFACES TO IMPROVE WELDING CHARACTERISTICS

(71) Applicant: Amee Bay, LLC, Hanahan, SC (US)

(72) Inventors: Ricky D. Jones, North Charleston, SC (US); Don Gurley, Ladson, SC (US); Karen Bruer, Hayes, VA (US); Thomas Devine, Chesapeake, VA (US); Mike Quinn, Chesapeake, VA (US)

(73) Assignee: AMEE BAY, LLC, Hanahan, SC (US)

(21) Appl. No.: 13/664,764

(22) Filed: Oct. 31, 2012

Related U.S. Application Data
(60) Provisional application No. 61/554,072, filed on Nov. 1, 2011.

(51) Int. Cl. B23K 31/02

(52) U.S. Cl. CPC B23K 31/02
USPC 228/205

(57) ABSTRACT

Metal surfaces that join together such as welded joints of foundations, hatches, railings, stanchions, decks, bulkheads and the like, crack, rust and corrode, occasionally to the point of failure, requiring repairs to be accomplished by welding. Before repair welding, the metal surfaces must be cleaned and may be cleaned using the dry ice (CO₂) blasting process of the present invention. The dry ice cleaning process of the present invention eliminates secondary environmentally hazardous waste streams and moisture, leaving the cleaned metal surfaces dry and immediately prepared for welding operations and/or preservation having removed contaminents from the surface and substrate of the metal as is proven by conductivity testing.

### CROSS-REFERENCE TO RELATED APPLICATIONS

The contents of Provisional Application U.S. Ser. No. 61/554,072 filed Nov. 1, 2011, on which the present application is based and benefit claimed under 35 U.S.C. §119(e), is incorporated by reference.

### BACKGROUND OF THE INVENTION

(1) Field of the Invention

The present invention relates to a process for using dry ice cleaning of metal surfaces to improve welding characteristics. More specifically, the present invention provides a process for reducing increased conductivity levels permeating metal surfaces due to environmental contamination, especially steel and aluminum, by cleaning surfaces to be welded with dry ice blasting.

(2) Description of Related Art

Metal surfaces exposed to the elements and regular usage accumulate grit, grime, grease, oil, chlorides, nitrates, sulfate, sodium and other contaminates which are deleterious to the surface of the metal. It is known that metals, especially steel and aluminum used in maritime applications and subjected to saltwater and harsh environmental conditions absorb contaminants in addition to increased oxidation properties. Conductivity measurements using the Bresle testing method are the primary means to empirically determine the level of surface contamination in operational use metals. This absorption phenomenon is a significant concern when working with maritime environmentally exposed metals since, as surface contamination and oxidation increases; weldability (a predominately electrically based process) is significantly degraded. Sound welds are achieved when the base material is properly prepared and free of contaminates which interfere with the ability of the base material to properly fuse with the weld filler metal. The adequacy of the welding process is proven by various Nondestructive Testing (NDT) methods. Salt, as a contaminant, causes damage to the base material—and often coatings—due to the hygroscopic nature of salt. The corrosive salt also has a tendency, once imbedded into a porous surface, to attract water on a molecular level, trapping it in the substrate and causing oxidation. This damage along with inherent contaminants, such as salt water, pollution, oil, sand and marine life resulting from operation of nautical vessels and the like, creates an electrolytic cell, and ultimately causes corrosion and presents difficulties when repairs become necessary.

Before welding, the metal surfaces are cleaned. Hand cleaning metal surfaces using brushes, scrapers and chemicals to remove accumulated debris is time consuming and expensive. Traditional mechanical approaches often use high pressure air to accelerate solid abrasive particle (often sand or steel grit) to high speeds, which impact the surface being cleaned. These methods result in large amounts of waste (the abrasive material and the debris), as well as requiring significant time and labor to remove blast media and moisture from the metal surfaces prior to preservation and return to service. Yet another drawback of the traditional grit blasting is the damage caused to the metal surface being cleaned. Furthermore, the metal surfaces must be maintained in a clean condition until the actual welding is done to minimize contaminants which might develop thereon. Additionally, when traditional blast cleaning is used; this method can actually increase conductivity problems as the blast media can force salt particles deeper into the metal surfaces.

Other traditional methods of in-service metal preparation prior to welding operations of steel and aluminum components include: grinding surface contact areas, the most commonly used field method, can adversely affect fit-up specifications if final material thickness is critical to the end use; additionally, this mechanical cleaning method does not remove contaminants from the substrate, nor does it reach geometrically restrictive areas. Water/chemical cleaning, another common method, creates environmentally harmful waste to little effect. Acid etching, which does clean the surface and substrate area well, is little used as it has a deleterious effect on the base material and can be harmful to personnel and the environment. These methods often do not address the increased conductivity levels of corroded, oxidized, metal which often result in poor welds.

Despite prior efforts to provide suitable processes for effectively cleaning metal surfaces in preparation for welding, there remains a desire to have a process that cleans metal surfaces in need thereof that does not require removal of the blasting material, removal of sound metal by decreasing material thickness, or the inherent personnel and environmental dangers of chemical cleaning solutions.

### SUMMARY OF THE INVENTION

It is therefore the general object of the present invention to provide a process for cleaning metal surfaces, both ferrous and non-ferrous, with dry ice to improve welding characteristics, while eliminating the environmentally hazardous secondary waste stream.

Another object of the present invention is to provide a dry ice cleaning process for preparing metal surfaces, especially those on ships, for welding by removing grit, grime, grease, oil, chlorides, nitrates, sulfate, sodium, dirt, loose paint, debris and other contaminants from the metal surfaces; thereby reducing the environmentally increased surface conductivity levels, and contaminants which have permeated into the substrate of metal surfaces exposed to use and/or the atmosphere resulting in better, stronger welds.

Yet another object of the present invention is to provide a dry ice cleaning process that reduces the chloride ion concentrations on the surface of the metals which in the case of potable water tanks reduces the need for extensive super-chlorination flushes.

Metal surface interfaces, such as welded joints of foundations, hatches, railings, stanchions, decks, bulkheads and the like, crack, rust and corrode, occasionally to the point of failure, requiring repairs to be accomplished by welding. Before repair welding, the metal surfaces must be cleaned and may be cleaned using the dry ice (CO₂) blasting process of the present invention.

The dry ice cleaning process of the present invention eliminates secondary waste streams and moisture, leaving the cleaned metal surfaces dry and immediately cleaned for welding operations and/or preservation having removed contaminents from the surface and substrate of the metal as is proven by reduced conductivity levels. Only the existing grit, grime, grease, oil, chlorides, nitrates, sulfate, sodium, dirt, loose paint, debris and other contaminants removed during the dry ice blasting process need to be cleaned up prior to repair, preservation and restoration/return to service. In most applications the debris can be removed through vacuuming or wiping without the significant labor and time resources required with traditional cleaning methods. Pelletized CO₂ is the only chemical ingredient used in the primary cleaning processes of this invention. The CO₂ sublimates on impact. Because pelletized CO₂ is the only ingredient used in the dry ice blasting cleaning method, the process is considered carbon net zero, as the sublimated CO₂ is returned to the atmosphere.

The proper dry ice blast cleaning operating parameters for thorough and efficiently cleaning of the metal surfaces for welding requires exacting conditions. These parameters include, for example, the size of the dry ice pellets, the discharge rate of the dry ice pellets, the type of nozzle being used, the flow rate of the pellets, angle of the nozzle to cleaning surface and the pressure of the pellets leaving the nozzle.

### DESCRIPTION OF THE PREFERRED EMBODIMENT(S)

The present invention now will be described more fully hereinafter, in which preferred embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

This invention uses compressed air to accelerate CO₂ (“dry ice”) pellets through high velocity nozzles to impinge upon and thereby clean corroded metal surfaces. The combination of kinetic and thermal shock breaks the bond between the residue/contaminant and the metal surface. The residue falls away from the surface and is easily wiped or vacuumed for removal. Upon impact, the dry ice particles transition from solid to gas, skipping the liquid stage, leaving no by-product, residue or moisture on the metal surface. It is significant to note there is no secondary environmentally hazardous material or waste generated from this method as is the case with all other cleaning processes in use today.

It has also been found that dry ice cleaning of metal surfaces, of both ferrous metals, like steel and stainless steel, non-ferrous metals like aluminum, copper/nickel alloys and nickel/chromium alloys, removes surface debris and contaminants, such as bacteria and the like, thereby reducing surface conductivity levels of the metal and surface chloride ion concentrations more easily and more effectively than traditional cleaning methods. This reduction in surface conductivity levels improves the ability to successfully weld the metal base materials, or weld repair excavation areas.

It should be appreciated that the term “dry ice,” as used herein, is for basic explanation and understanding of the operation of the process of this invention. Therefore, the term “dry ice” is not be construed as limiting the cleaning processes of this invention and any material or combination of materials capable of sublimation upon impact can be used without departing from the spirit and scope of the invention.

The process of this invention employs existing commercial grade dry ice supplying equipment and uses closely controlled parameters to conduct cleaning operations wherein dry ice pellets are fed under pressure through a hose to a nozzle and blasted against the metal surface to dislodge debris and remove contaminates. Pelletized CO₂ is the only chemical ingredient used in dry ice blasting cleaning processes of this invention. The CO₂ sublimates on impact with the surface being treated, expanding to nearly 800 times the original size of the pellet. The process of this invention is carbon net zero as the CO₂ is returned to the atmosphere.

The dry ice cleaning process of the present invention eliminates secondary waste streams and moisture, leaving the cleaned metal surfaces dry and immediately prepared for welding operations and/or preservation having removed contaminants from the surface and substrate of the metal as is proven by conductivity testing. Only the existing grit, grime, grease, oil, chlorides, nitrates, sulfate, sodium, dirt, loose paint, debris and other contaminants removed during the dry ice blasting process need to be gathered and disposed of prior to repair, preservation and restoration/return to service. In most applications the debris can be removed through vacuuming or wiping without the significant labor and time resources required with traditional cleaning methods.

The dry ice supplier (referred to as a “ Cleaning System”) includes an ice hopper with air dryer, an air compressor, and accompanying high pressure hose equipment. The air compressor may be of any commercial type but a high pressure compressor having a rating of air flow up to 500 ft³/min. at a maximum pressure of around 250 psi is preferred.

In cleaning various metal surfaces, both ferrous and non-ferrous items, the size of the dry ice pellet will vary but is generally between about 2.5 mm and about 3.5 mm, most preferably about 2.5 mm. The dry ice flow rate will vary, depending upon the corrosion/contamination present, between about 2 lbm/hr for lightly oxidized and/or contaminated areas and about 3 lbm/hr for heavily oxidized and/or contaminated areas.

The capability of the dry ice cleaning system to remove debris from the surface being treated is dependent upon the strength of air compressor discharge which ranges from a rate of about 50 psi to about 200 psi of pressure. The air compressor humidity requirements range from about 20° F. to 40° F. reduction in dew point from suction to nozzle discharge.

A particular application of the process of this invention preferably uses a specific nozzle. For example, when cleaning the metal surface of shipboard vertical conveyors a 90° fan nozzle type is preferred. When cleaning the metal surfaces of non-skid areas and bilges a shotgun-type nozzle is preferred. A shotgun nozzle is a rectangular outlet in a nozzle that has a direct blast pattern.

The rate at which the nozzle is passed over the surface to be cleaned and the type of extrusion of the dry ice is likewise important. More specifically, a nozzle sweep rate of about 8 to 12 ft/min., preferably about 10 ft/min. (cleaning an approximate 12 square foot area), is used when cleaning larger areas such as bulkheads, decks, non-skid areas and bilges. However, a nozzle sweep rate 3 to 5 ft/min., preferably about 4 ft/min. (cleaning an approximate 5 square foot area), is used when cleaning smaller metal surface areas.

Other parameters for achieving a clean surface include using the correct angle of impingement of the dry ice pellets which varies from about 25° to about 55° from parallel to the surface being cleaned. This applies to each of the cleaning processes discussed herein. To optimize cleaning, the nozzle is held about 3 inches to 5 inches from the surface being cleaned.

### Example 1

This example illustrates the capability of dry ice cleaning to reduce the increased conductivity levels permeated into material, specifically aluminum, which have been exposed to saltwater and harsh environmental conditions while in operation. In order to show that the dry ice process cleans the in-service metal surfaces and reduces existing electrical conductivity levels, access to an Aluminum Air Cushioned Craft that was due for a fresh water wash was obtained. An inspection company performed conductivity testing on both areas before cleaning took place and immediately after cleaning was performed. The use of dry ice blasting was performed on each spot for approximately one minute with the use of an AERO 40 HIP Dry Ice Machine and a 375 CFM compressor. Location of spot 1 was on the underside of the ramp and the second location was 3′ (0.91 m) in front of location 1. Readings were taken with a B-173 Horiba Gauge. The results of the testing were:

| | Conductivity Level—3 ml | | |
|---|---|---|---|
| | of DI H₂O in Bresele cell | | |
| | (Not to exceed 70 μS/cm in | | |
| | non-immersion areas) | | |
| | (Not to exceed 30 μS/cm in | | |
| Location | immersion areas) | | Comments |
| Location 1 | 2000 | mS/cm | First reading |
| | | | before cleaning |
| Location 1 | 161 | mS/cm | After cleaning |
| Location 2 | 183 | mS/cm | First reading |
| | | | before cleaning |
| Location 2 | 40 | mS/cm | After cleaning |

The test results empirically exhibit a reduction in the conductivity levels present in the material; moreover it was discovered that slight increases in pressure and contact time improved results. This experiment demonstrates the ability of the dry ice cleaning process to appreciably improve weldability by returning the base metal to as close to an unused (like new) condition as possible without any of the aforementioned harmful side effects.

### Example 2

The second part of the test was to determine if the process improved the weldability of the material cleaned. A specimen (aluminum plate previously removed from an Air Cushion Craft and dry ice blasted) of subject material was used in weldability experiments. In this part of the test, the subject piece of existing, environmentally exposed and cleaned metal was cut, and the two pieces were welded together, simulating repairs performed on existing previously exposed material. Additionally a new, unexposed piece of material, cleaned with only acetone, was welded to a piece of existing metal, simulating the joining of new and service exposed materials. In both cases the welder stated there were no problems.

Both weld samples underwent Visual and Liquid Penetrant Nondestructive testing (NDT) by a certified NDT Level II inspector and an American Society for Nondestructive Testing (ASNT) certified NDT Level III Examiner. Both welds satisfactorily passed inspections without additional processing. Finally, a break test was performed on both welds. In both specimens the test broke in the center of the welds, proving satisfactory penetration was achieved. Visual examination of the weld break area showed no relevant indications and the destructive test confirmed a satisfactory testing cycle.

When applied using the proper combination of pressure, flow rate, duration, and pellet size the cleaning process, significantly increased the weldability qualities of aluminum exposed to maritime operations. Additionally, the process simultaneously provides a surface area free of dirt and contaminants ready for protective coating applications without generating a secondary environmentally hazardous waste during any part of cleaning process.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A process of reducing increased surface conductivity levels permeated into metals, which comprises;
(a) blasting weldable metal surfaces having debris and contaminants thereon with an amount of dry ice pellets sufficient to dislodge at least a substantial portion of said debris and contaminants and provide metal surfaces suitable for welding, and
(b) removing said dislodged debris from the cleaned surfaces; whereby the welding characteristics of the metal surfaces are improved.

2. The process according to claim 1 further comprising welding said metal surfaces together.

3. The process according to claim 1 wherein said metal surfaces are ferrous metals.

4. The process according to claim I wherein said metal surfaces are a non-ferrous metal selected from the group consisting of aluminum, copper/nickel alloys and Inconel alloys.

5. The process according to claim 1 wherein said dry ice pellets have a diameter between about 2.5 mm and about 3.5 mm.

6. The process according to claim 1 wherein said dry ice pellets are supplied from an ice hopper operating at a pressure of 50 to about 250 psi by passing said pellets from the ice hopper through an accompanying high pressure hose and nozzle at a flow rate of up to 500 ft³/min.

7. The process according to claim 1 wherein said dry ice pellets are supplied from an ice hopper having an air compressor operating at a flow rate of between about 200 ft³/min to about 300 ft³/min.

8. The process according to claim 1 wherein said cleaning system is accomplished using a nozzle sweep of from about 8 ft/min to about 12 ft/min

9. A process for cleaning ferrous or non-ferrous metal surfaces having dirt, loose paint, debris and contaminants thereon comprising:
(a) blasting said metal surfaces with dry ice pellets said dry ice pellets having a diameter between about 2.5 mm and about 3.5 mm at a pressure between about 50 to about 250 psi by passing said pellets from the ice hopper through an accompanying high pressure hose and nozzle at a flow rate of up to 500 ft³/min. to dislodge at least a substantial portion of the loose paint, debris and contaminants from the metal surface to provide clean metal surfaces;
(b) removing said dislodged loose paint, debris, and contaminants from said cleaned surfaces; and
(c) improving welding characteristics of said clean metal surfaces together.

10. The process according to claim 9 wherein said dry ice pellets have a diameter between about 2.5 mm and about 3.5.

11. The process according to claim 9 wherein said dry ice pellets are supplied from an ice hopper having an air compressor operating at a flow rate of between about 200 ft³/min to about 300 ft³/min.

12. The process according to claim 9 wherein said dislodged loose paint, debris, and contaminants are removed from said cleaned metal surfaces using a vacuum, or in some cases by wiping.
